(19) United States
(12) Patent Application Publication
(10) Pub. No.: US 2023/0350258 A1
(43) Pub. Date: Nov. 2, 2023

(54) ELECTROCHROMIC DEVICE AND METHOD FOR CONTROLLING AN ELECTROCHROMIC DEVICE

(71) Applicant: GUANGYI INTELLIGENT TECH (SUZHOU) CO., LTD, Jiangsu (CN)

(72) Inventor: Chenbi XIONG, Jiangsu (CN)

(73) Assignee: GUANGYI INTELLIGENT TECH (SUZHOU) CO., LTD, Jiangsu (CN)

(21) Appl. No.: 18/351,103

(22) Filed: Jul. 12, 2023

Related U.S. Application Data
(63) Continuation of application No. PCT/CN2022/070945, filed on Jan. 10, 2022.

(30) Foreign Application Priority Data
Jan. 13, 2021 (CN) 202110042216.4

(51) Int. Cl. G02F 1/155; G02F 1/163

(52) U.S. Cl. CPC G02F 1/155; G02F 1/163

(57) ABSTRACT

Provided are an electrochromic device and a control method. For each two adjacent electrochromic regions of the electrochromic device, the first electrochromic region includes a first base layer, a first conductive layer, a first electrochromic layer, a second conductive layer, and a second base layer stacked in sequence. The second electrochromic region includes a third base layer, a third conductive layer, a second electrochromic layer, a fourth conductive layer, and a fourth base layer stacked in sequence. The first conductive layer is electrically connected to the third conductive layer. The second conductive layer is not in contact with the fourth conductive layer. The edge of the first electrochromic layer is insulated from the edge of the second electrochromic layer. A first lead-out electrode and a second lead-out electrode are electrically connected respectively on the second conductive layer and the fourth conductive layer that are located at peripheries.

### CROSS-REFERENCE TO RELATED APPLICATIONS

This is a continuation of International Patent Application No. PCT/CN2022/070945, filed on Jan. 10, 2022, which claims priority to Chinese Patent Application No. 202110042216.4 filed with the China National Intellectual Property Administration (CNIPA) on Jan. 13, 2021, the disclosures of which are incorporated herein by reference in their entireties.

### TECHNICAL FIELD

The present application relates to the field of electrochromic technology, for example, an electrochromic device and a method for controlling an electrochromic device.

### BACKGROUND

An electrochromic device is a device that can respond to an external potential difference to change the optical performance of the electrochromic device. The variation in its optical performance is mainly caused by the ion insertion/desorption of an electrochromic material in the electrochromic device. In the related art, the optical performance of an electrochromic device is usually switched between a coloration state and a decoloration state (transparent state). For example, when applied, the electrochromic device may be combined into a window to form an electrochromic window. When strong ambient light exists, a user may switch the optical state of the window to the coloration state (such as gray or blue), thereby weakening the light ray intensity to a certain extent, and improving body comfort. When the ambient light intensity is relatively weak, the user may switch the optical state of the window to the decoloration state, increasing the ratio of incident light intensity so as to increase indoor brightness.

However, with the width of the electrochromic device increasing gradually, since a conductive layer used by the electrochromic device has a surface resistance, an effective voltage on the surface of the electrochromic device may be caused to be nonuniform. That is, the effective voltage on the periphery is greater than the effective voltage in the center. Therefore, when the electrochromic device changes color, the periphery changes color fast, while the center changes color slowly. Moreover, the larger the width of the electrochromic device, the more obvious the nonuniformity of color changing and the longer the time required by the center for reaching the end point of color changing.

### SUMMARY

The present application provides an electrochromic device and a method for controlling an electrochromic device to solve the issue of the low color changing speed in the center of a large-width electrochromic device and the nonuniform color changing of the whole.

The present application provides an electrochromic device. The electrochromic device includes at least two electrochromic regions. For each two adjacent electrochromic regions of the at least two electrochromic regions, including a first electrochromic region and a second electrochromic region, the first electrochromic region includes a first base layer, a first conductive layer, a first electrochromic layer, a second conductive layer, and a second base layer that are stacked in sequence. The second electrochromic region includes a third base layer, a third conductive layer, a second electrochromic layer, a fourth conductive layer, and a fourth base layer that are stacked in sequence. The first conductive layer is electrically connected to the third conductive layer. The second conductive layer is not in contact with the fourth conductive layer. The edge of the first electrochromic layer is insulated from the edge of the second electrochromic layer.

If the first electrochromic region is located at a periphery of the electrochromic device, a first lead-out electrode is electrically connected to the second conductive layer. If the second electrochromic region is located at the periphery of the electrochromic device, a second lead-out electrode is electrically connected to the fourth conductive layer.

In an embodiment, the first electrochromic layer includes a first electrochromic material layer, a first ion conduction layer, and a first ion storage layer that are stacked in sequence. The second electrochromic layer includes a second electrochromic material layer, a second ion conduction layer, and a second ion storage layer that are stacked in sequence.

The first electrochromic material layer is in proximity to the first conductive layer, and the second ion storage layer is in proximity to the third conductive layer. Alternatively, the first ion storage layer is in proximity to the first conductive layer, and the second electrochromic material layer is in proximity to the third conductive layer.

In an embodiment, the first electrochromic layer includes a first electrochromic material layer, a first ion conduction layer, and a first ion storage layer that are stacked in sequence. The second electrochromic layer includes a second electrochromic material layer, a second ion conduction layer, and a second ion storage layer that are stacked in sequence.

The first electrochromic material layer is in proximity to the first conductive layer, and the second electrochromic material layer is in proximity to the third conductive layer. Alternatively, the first ion storage layer is in proximity to the first conductive layer, and the second ion storage layer is in proximity to the third conductive layer.

In an embodiment, the at least two electrochromic regions have a same width.

In an embodiment, a third lead-out electrode is electrically connected to an electrical connection between the first conductive layer and the third conductive layer.

In an embodiment, the electrochromic device further includes a controller. The controller is connected to the first lead-out electrode, the second lead-out electrode, and at least one third lead-out electrode. The controller is configured to control, through the first lead-out electrode and the second lead-out electrode, the entire electrochromic device to perform color changing and control, through the first lead-out electrode, the second lead-out electrode, and the at least one third lead-out electrode, each electrochromic region in the electrochromic device to perform color changing.

The present application further provides a method for controlling an electrochromic device, which is applied to the preceding electrochromic device including a controller, comprising:

Receiving a transmittance adjustment control signal of the electrochromic device;

According to the transmittance adjustment control signal, determining whether the entire electrochromic device is controlled or a single electrochromic region in the electrochromic device is controlled;

If the entire electrochromic device is controlled, controlling the entire electrochromic device through the first lead-out electrode of the electrochromic device and the second lead-out electrode of the electrochromic device to perform color changing; and

If the single electrochromic region in the electrochromic device is controlled, controlling the single electrochromic region through lead-out electrodes electrically connected to two conductive layers in the single electrochromic region to perform color changing.

In an embodiment, if the entire electrochromic device is controlled, before controlling the entire electrochromic device through the first lead-out electrode of the electrochromic device and the second lead-out electrode of the electrochromic device to perform color changing, the method further includes the step below:

Adjusting the at least two electrochromic regions in the electrochromic device to have a same coloring degree or complementary coloring degrees.

In an embodiment, if the entire electrochromic device is controlled, before adjusting the at least two electrochromic regions in the electrochromic device to have the same coloring degree or the complementary coloring degrees, the method further includes the steps below:
Determining whether each electrochromic region in the electrochromic device is damaged; and
In response to a target electrochromic region being damaged, shorting lead-out electrodes electrically connected to two conductive layers in the target electrochromic region.

In an embodiment, the step of determining whether each electrochromic region in the electrochromic device is damaged includes the steps below:
Controlling each electrochromic region in the electrochromic device to perform color changing, and acquiring a current of each electrochromic region in a control process; and
If a current of the target electrochromic region exceeding a preset current threshold exists, determining that the target electrochromic region is damaged.

### BRIEF DESCRIPTION OF DRAWINGS

FIG. 1 is a structural diagram of an electrochromic device according to an embodiment of the present application.

FIG. 2 is a structural diagram of another electrochromic device according to an embodiment of the present application.

FIG. 3 is a structural diagram of another electrochromic device according to an embodiment of the present application.

FIG. 4 is a structural diagram of another electrochromic device according to an embodiment of the present application.

FIG. 5 is a structural diagram of another electrochromic device according to an embodiment of the present application.

FIG. 6 is a structural diagram of another electrochromic device according to an embodiment of the present application.

FIG. 7 is a structural diagram of another electrochromic device according to an embodiment of the present application.

FIG. 8 is a structural diagram of another electrochromic device according to an embodiment of the present application.

FIG. 9 is a structural diagram of another electrochromic device according to an embodiment of the present application.

FIG. 10 is a flowchart of a method for controlling an electrochromic device according to an embodiment of the present application.

### DETAILED DESCRIPTION

The present application is described below in conjunction with drawings and embodiments. Specific embodiments described herein are merely intended to explain the present application. For ease of description, only part related to the present application is illustrated in the drawings.

Additionally, the terms “first,” “second” and the like may be used herein to describe multiple directions, actions, steps, elements, or the like, but these directions, actions, steps, or elements are not limited by these terms. These terms are only used for distinguishing one direction, action, step or element from another direction, action, step, or element. Terms like “first,” “second” and the like are not to be construed as indicating or implying relative importance or implicitly indicating the number of technical features as indicated. Thus, a feature defined as a “first” feature or a “second” feature may explicitly or implicitly include one or more of such features.

Before the example embodiments are discussed, it is to be noted that some of the example embodiments are described as processing or methods depicted in flowcharts. Although multiple steps are described as sequential processing in the flowcharts, many of the steps may be implemented concurrently, coincidentally, or simultaneously. Additionally, the sequence of the multiple steps may be rearranged. The processing may be terminated when the operations are completed, but the processing may further have additional steps that are not included in the drawings. The processing may correspond to a method, a function, a procedure, a subroutine, a subprogram, or the like.

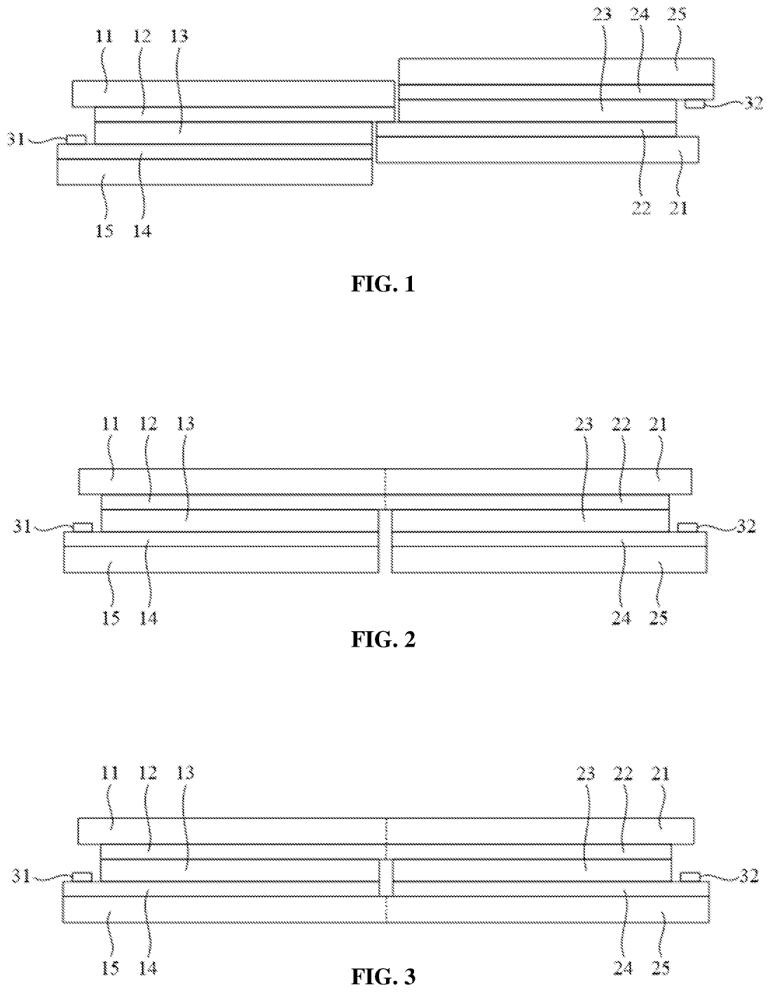

FIG. 1 is a structural diagram of an electrochromic device according to an embodiment of the present application. As shown in FIG. 1, the electrochromic device includes at least two electrochromic regions (FIG. 1 illustrates an example in which two electrochromic regions are included). For each two adjacent electrochromic regions, including a first electrochromic region and a second electrochromic region, the first electrochromic region includes a first base layer 11, a first conductive layer 12, a first electrochromic layer 13, a second conductive layer 14, and a second base layer 15 that are stacked in sequence. The second electrochromic region includes a third base layer 21, a third conductive layer 22, a second electrochromic layer 23, a fourth conductive layer 24, and a fourth base layer 25 that are stacked in sequence. The first conductive layer 12 is electrically connected to the third conductive layer 22. The second conductive layer 14 is not in contact with the fourth conductive layer 24. The edge of the first electrochromic layer 13 is insulated from the edge of the second electrochromic layer 23. If the first electrochromic region is located at the periphery of the electrochromic device, a first lead-out electrode 31 is electrically connected to the second conductive layer 14. If the second electrochromic region is located at the periphery of the electrochromic device, a second lead-out electrode 32 is electrically connected to the fourth conductive layer 24.

The example in which the electrochromic device includes two electrochromic regions is taken for description. The first electrochromic region and the second electrochromic region are connected in series through the electrical connection between the first conductive layer 12 and the third conductive layer 22 and the non-contact between the second conductive layer 14 and the fourth conductive layer 24. The edge of the first electrochromic layer 13 is a surface that is not in contact with the first conductive layer 12 and the second conductive layer 14. The edge of the second electrochromic layer 23 is a surface that is not in contact with the third conductive layer 22 and the fourth conductive layer 24. The case where the edge of the first electrochromic layer 13 is insulated from the edge of the second electrochromic layer 23 includes the following: A gap of a preset width is disposed between the edge of the first electrochromic layer 13 and the edge of the second electrochromic layer 23, or an electronic insulating material is disposed between the edge of the first electrochromic layer 13 and the edge of the second electrochromic layer 23. Exemplarily, the electronic insulating material may be, for example, an insulating colloid, an ionic conduction layer material, and the like. As shown in FIG. 1, the first base layer 11 and the fourth base layer 25 are separated structures, and the second base layer 15 and the third base layer 21 are separated structures. In another embodiment, on the basis of the structure shown in FIG. 1, the first base layer 11 and the fourth base layer 25 may be arranged as an integrally connected structure, and/or the second base layer 15 and the third base layer 21 may be arranged as an integrally connected structure. The arrangement in which the edge of the first electrochromic layer 13 is insulated from the edge of the second electrochromic layer 23 can effectively avoid a short circuit inside the electrochromic device. In an embodiment, one or at least two of the first conductive layer 12, the second conductive layer 14, the third conductive layer 22 and the fourth conductive layer 24 may be each a monolayer conductive layer with a uniform surface resistance, or a monolayer conductive layer with a nonuniform surface resistance, or a multilayer conductive layer stacked by multiple conductive materials with different electrical resistivity. In this case, the first lead-out electrode 31 is electrically connected to the second conductive layer 14, and the second lead-out electrode 32 is electrically connected to the fourth conductive layer 24. Accordingly, the first electrochromic region and the second electrochromic region are controlled to perform color changing by applying a voltage between the first lead-out electrode 31 and the second lead-out electrode 32. That is, the path of the voltage is from the second conductive layer 14 to the first conductive layer 12, then to the third conductive layer 22, and finally to the fourth conductive layer 24. The first electrochromic region and the second electrochromic region are connected in series, so the voltage applied between the first lead-out electrode 31 and the second lead-out electrode 32 is divided by the two electrochromic regions together. That is, a divided voltage is applied to each electrochromic region respectively to control the two electrochromic regions to perform color changing simultaneously, thereby improving the color changing speed of the entire electrochromic device. Moreover, the arrangement of dividing the large-width electrochromic device into several smaller electrochromic regions reduces the effect of the surface resistance of the conductive layer on a color changing process, thereby improving the color changing uniformity of each electrochromic region.

As shown in FIG. 1, the first conductive layer 12 and the third conductive layer 22 may be bonded through a conductive medium. The conductive medium may be, for example, a conductive adhesive or a conductive silver paste, and so on. The conductive adhesive may further include one or more of a conductive adhesive, a conductive acrylic acid, a conductive silver adhesive, and the like. Alternatively, as shown in FIG. 2, the first conductive layer 12 and the third conductive layer 22 may be an integrally connected structure. Correspondingly, the first base layer 11 and the third base layer 21 may also be an integrally connected structure. Alternatively, as shown in FIG. 3, the second base layer 15 and the fourth base layer 25 may also be an integrally connected structure as long as the insulation between the edge of the first electrochromic layer 13 and the edge of the second electrochromic layer 23 and the non-contact between the second conductive layer 14 and the fourth conductive layer 24 are guaranteed.

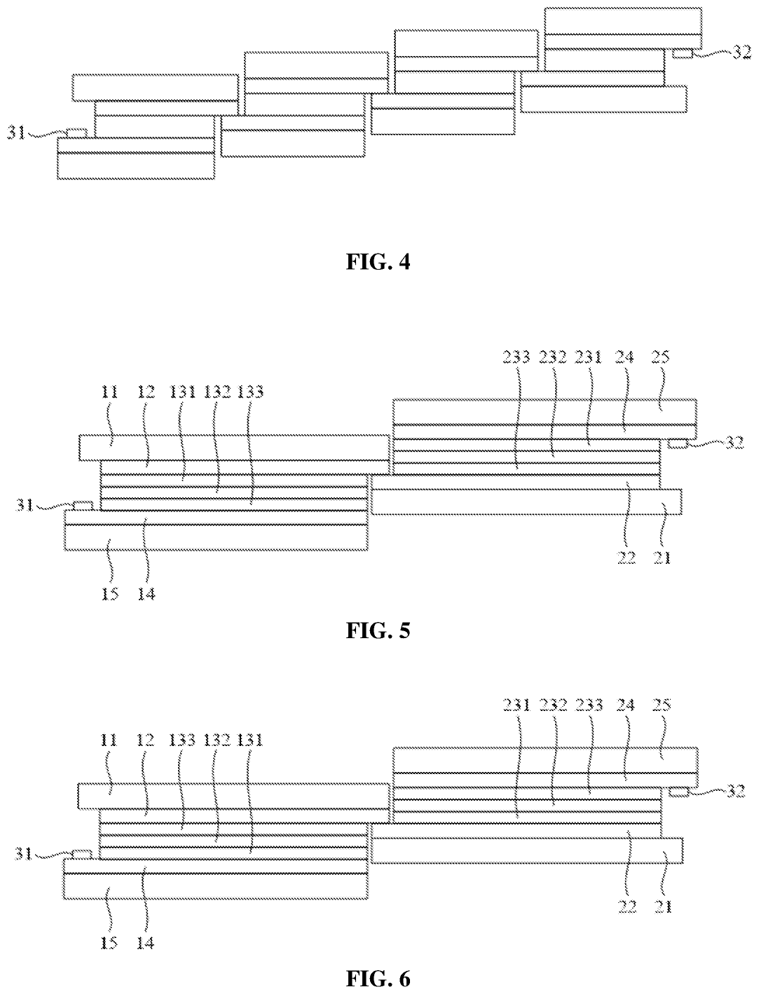

When the electrochromic device includes three or more electrochromic regions, the structure of the electrochromic device may be shown in FIG. 4 (FIG. 4 illustrates an example of four electrochromic regions). Two conductive layers of each electrochromic region located inside the electrochromic device are electrically connected to one conductive layer of adjacent electrochromic regions on the two sides of the electrochromic region, respectively. One conductive layer of an electrochromic region located at the periphery is electrically connected to one conductive layer of an adjacent electrochromic region. The electrical connection between each two adjacent electrochromic regions is the same as in the preceding case which includes two electrochromic regions. The other conductive layer of the electrochromic region located at the periphery is configured to be electrically connected to a lead-out electrode. That is, the first lead-out electrode 31 and the second lead-out electrode 32 are electrically connected to the peripheries on two sides of the electrochromic device, respectively. In this case, the four electrochromic regions in the electrochromic device are connected in series to divide the voltage applied between the first lead-out electrode 31 and the second lead-out electrode 32.

In an embodiment, at least two electrochromic regions have the same width. In this case, voltages divided to the at least two electrochromic regions are equal. It is assumed that the overall width of the electrochromic device in this embodiment is the same as the overall width of a traditional electrochromic device. Compared with the traditional electrochromic device, if a voltage having a value of a multiple of the number of electrochromic regions is applied between the first lead-out electrode 31 and the second lead-out electrode 32, a voltage divided to each electrochromic region may be the same as the voltage applied to the traditional electrochromic device. The width of each electrochromic region is greatly reduced compared with the traditional electrochromic device. In this case, on the basis of improving the color changing speed of the entire electrochromic device and the color changing uniformity of each electrochromic region, color changing speeds of multiple electrochromic regions and coloring degrees of multiple electrochromic regions can be synchronized. In the case where multiple electrochromic regions change color in the same direction, the color changing uniformity of the entire electrochromic device is improved.

In an embodiment, as shown in FIGS. 5 and 6 (FIGS. 5 and 6 illustrate the example in which two electrochromic regions are included). The first electrochromic layer includes a first electrochromic material layer 131, a first ion conduction layer 132, and a first ion storage layer 133 that are stacked in sequence. The second electrochromic layer includes a second electrochromic material layer 231, a second ion conduction layer 232, and a second ion storage layer 233 that are stacked in sequence. The first electrochromic material layer 131 is in proximity to the first conductive layer 12, and the second ion storage layer 233 is in proximity to the third conductive layer 22 (as shown in FIG. 5). Alternatively, the first ion storage layer 133 is in proximity to the first conductive layer 12, and the second electrochromic material layer 231 is in proximity to the third conductive layer 22 (as shown in FIG. 6). In the preceding cases, voltages applied to the two electrochromic regions are in the same direction. In the two electrochromic regions, the positions of two ion storage layers are the same and the positions of two electrochromic material layers are the same. When the voltage is applied between the first lead-out electrode 31 and the second lead-out electrode 32, coloring states of the two electrochromic regions are the same; that is, color changing is implemented in the same direction. The coloring states include a coloration state, an intermediate state, and a decoloration state. The intermediate state is a state in which an open-circuit voltage in an electrochromic region is 0 V. On the basis of the intermediate state, the transmittance decreases to enter the coloration state and increases to enter the decoloration state. In electrochromic devices of other types, the coloring states include only the coloration state or the decoloration state. The coloration state or the decoloration state is a state in which an open-circuit voltage in an electrochromic region is 0 V. The coloration state of the electrochromic region and the decoloration state of the electrochromic region may each include a range; that is, multiple coloring levels are divided according to the magnitude of the transmittance. Different coloring levels correspond to different coloring degrees of the electrochromic region. In this case, the two electrochromic regions in FIGS. 5 and 6 may have the same coloring degree or different coloring degrees, which may be implemented by configuring the width relationship of the two electrochromic regions. For example, when the widths of the two electrochromic regions are the same, the two electrochromic regions have the same coloring state and the same coloring degree, thereby making the color changing effect of the entire electrochromic device better. When the two electrochromic regions have different widths, the coloring degree of the wider region may be lower than the coloring degree of the narrower region. In this case, the effect of gradation in the same direction can be implemented, thereby satisfying requirements in some specific situations.

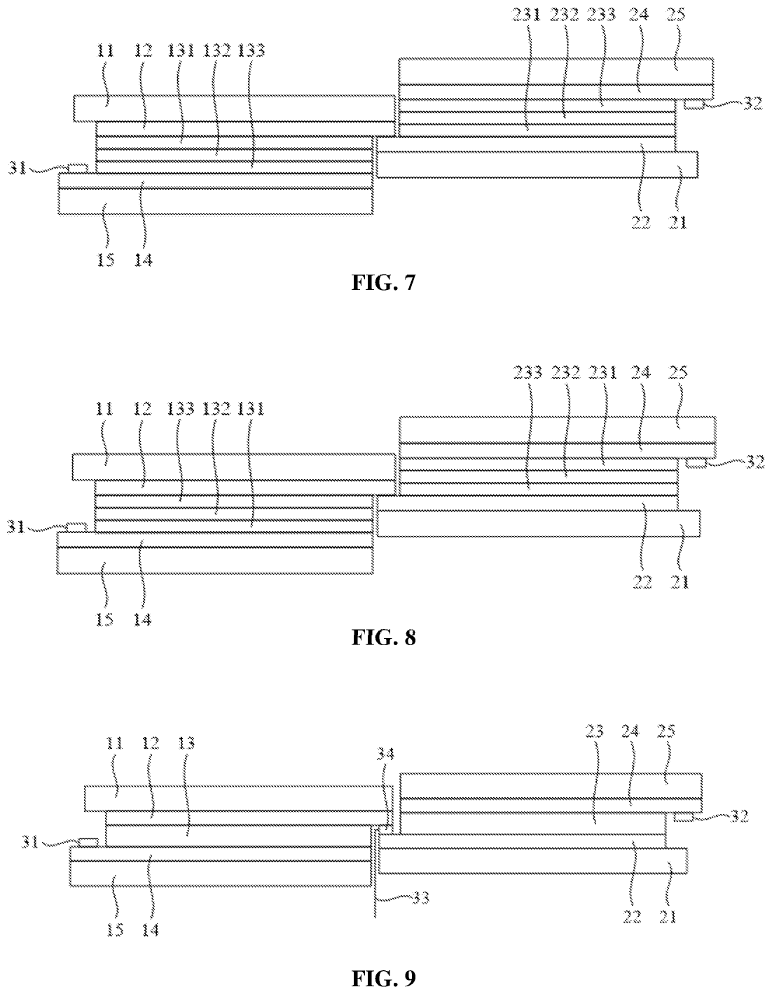

Alternatively, as shown in FIGS. 7 and 8 (FIGS. 7 and 8 illustrate the example in which two electrochromic regions are included). The first electrochromic layer includes a first electrochromic material layer 131, a first ion conduction layer 132, and a first ion storage layer 133 that are stacked in sequence. The second electrochromic layer includes a second electrochromic material layer 231, a second ion conduction layer 232, and a second ion storage layer 233 that are stacked in sequence. The first electrochromic material layer 131 is in proximity to the first conductive layer 12, and the second electrochromic material layer 231 is in proximity to the third conductive layer 22 (as shown in FIG. 7). Alternatively, the first ion storage layer 133 is in proximity to the first conductive layer 12, and the second ion storage layer 233 is in proximity to the third conductive layer 22 (as shown in FIG. 8). In the preceding cases, voltages applied to the two electrochromic regions are in the opposite directions. In the two electrochromic regions, the two ion storage layers are in opposite positions and the two electrochromic material layers are opposite positions. When the voltage is applied between the first lead-out electrode 31 and the second lead-out electrode 32, coloring states of the two electrochromic regions are opposite (for example, the coloring state of one electrochromic region is the coloration state, while the coloring state of the other electrochromic region is the decoloration state); that is, color changing is implemented in different directions. Moreover, the two electrochromic regions have different coloring degrees. However, when the two electrochromic regions have the same width, the two electrochromic regions may have complementary coloring degrees. That is, the coloring degrees of the two electrochromic regions have the same level number from the intermediate state (for example, one electrochromic region is in an N^{th} coloring level of the coloration state, and the other electrochromic region is in an N^{th} coloring level of the decoloration state). When the two electrochromic regions change color in different directions, the effect of gradation in different directions can be implemented by configuring the width relationship of the two electrochromic regions, thereby satisfying requirements under more scenarios.

For the electrochromic device according to the embodiments of the present application, the electrochromic device is divided into at least two electrochromic regions, and the at least two electrochromic regions are configured to be sequentially connected in series. Then a first lead-out electrode and a second lead-out electrode are electrically connected to the electrochromic regions at the peripheries on two sides of the electrochromic device. In this case, multiple electrochromic regions are controlled through the first lead-out electrode and the second lead-out electrode to change color simultaneously, thereby improving the color changing speed of the entire large-width electrochromic device and the color changing uniformity of the multiple electrochromic regions.

FIG. 9 is a structural diagram of another electrochromic device according to an embodiment of the present application. The technical scheme of this embodiment is described on the basis of the technical solution of the preceding embodiment. Alternatively, as shown in FIG. 9, a third lead-out electrode 33 is electrically connected to an electrical connection between the first conductive layer 12 and the third conductive layer 22 (FIG. 9 illustrates the example in which two electrochromic regions are included and in which the first electrochromic region and the second electrochromic region are bonded through a conductive medium 34). If the electrochromic device includes three or more electrochromic regions, a third lead-out electrode 33 is electrically connected to the position between each two electrochromic regions, thereby implementing the independent control of each electrochromic region through the third lead-out electrode 33. As shown in FIG. 9, the coloring state and the coloring degree of the first electrochromic region can be controlled independently by applying a voltage between the first lead-out electrode 31 and the third lead-out electrode 33. The coloring state and the coloring degree of the second electrochromic region can be controlled independently by applying a voltage between the second lead-out electrode 32 and the third lead-out electrode 33.

Alternatively, the electrochromic device also includes a controller. The controller is connected to the first lead-out electrode 31, the second lead-out electrode 32, and at least one third lead-out electrode 33. The controller is configured to control, through the first lead-out electrode 31 and the second lead-out electrode 32, the entire electrochromic device to perform color changing and control, through the first lead-out electrode 31, the second lead-out electrode 32, and the at least one third lead-out electrode 33, each electrochromic region in the electrochromic device to perform color changing. An adjustment manner may be determined according to a transmittance adjustment control signal received by the controller. When it is determined that the entire electrochromic device requires to be adjusted, a required voltage is applied to the entire electrochromic device through the first lead-out electrode 31 and the second lead-out electrode 32. When it is determined that one single electrochromic region in the electrochromic device requires to be adjusted, a required voltage is applied to the single electrochromic region through the first lead-out electrode 31 and a third lead-out electrode 33 that correspond to the single electrochromic region, or through two third lead-out electrodes 33 corresponding to the single electrochromic region, or through the second lead-out electrode 32 and a third lead-out electrode 33 that correspond to the single electrochromic region.

For the electrochromic device according to this embodiment of the present application, a third lead-out electrode is electrically connected to an electrical connection of every two adjacent electrochromic regions in the electrochromic device. In this case, on the basis of improving the color changing speed of the entire large-width electrochromic device, a color changing process of a single electrochromic region is controlled independently, thereby satisfying requirements under more scenarios and facilitating the debugging and maintenance of the electrochromic device.

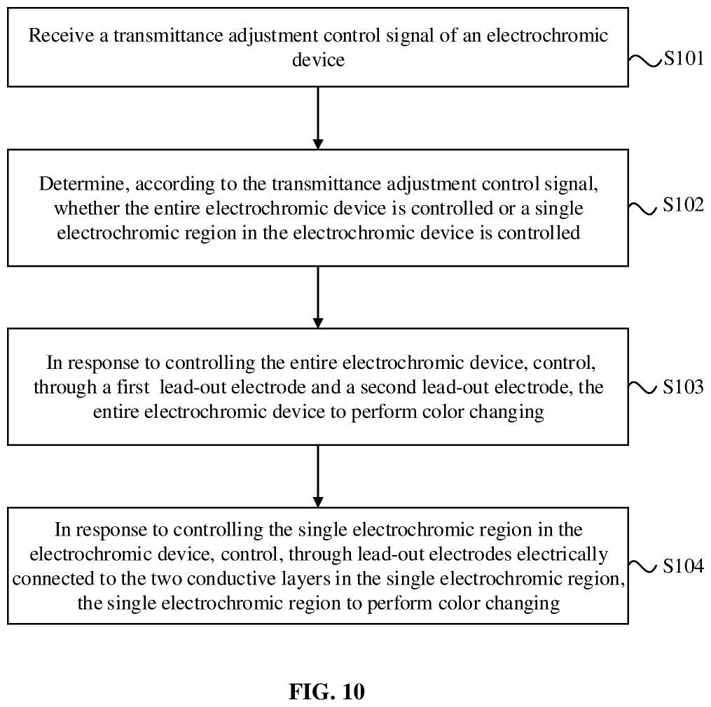

FIG. 10 is a flowchart of a method for controlling an electrochromic device according to an embodiment of the present application. This embodiment is applicable to the preceding case where a color changing process of the electrochromic device including a controller is controlled. The method may be performed by the controller disposed in the electrochromic device. As shown in FIG. 10, the method includes the steps below.

In S101, a transmittance adjustment control signal of the electrochromic device is received.

In S102, it is determined according to the transmittance adjustment control signal whether the entire electrochromic device is controlled or a single electrochromic region in the electrochromic device is controlled.

In S103, in response to controlling the entire electrochromic device, the entire electrochromic device is controlled through a first lead-out electrode and a second lead-out electrode to perform color changing.

In S104, in response to controlling the single electrochromic region in the electrochromic device, the single electrochromic region is controlled through extraction electrodes electrically connected to two conductive layers in the single electrochromic region to perform color changing.

During the use of the electrochromic device, a user may trigger the generation of a transmittance adjustment control signal through an operation according to requirements for the transmittance of the electrochromic device. Exemplarily, an adjustment button is disposed outside the electrochromic device. When the user presses the button, one transmittance adjustment control signal is generated and received by the controller in the electrochromic device. Additionally, the electrochromic device may also generate the transmittance adjustment control signal spontaneously according to the surrounding environment. Exemplarily, the electrochromic device may acquire environment brightness based on a certain period, generate one transmittance adjustment control signal automatically according to the required transmittance corresponding to the environment brightness, and send the transmittance adjustment control signal to the controller for processing. The manner of generating the transmittance adjustment control signal is not limited in this embodiment and not limited to the preceding example.

After the transmittance adjustment control signal for the electrochromic device is received, it may be determined according to the transmittance adjustment control signal whether the entire electrochromic device is adjusted or one single electrochromic region in the electrochromic device is adjusted so that a voltage is applied through different lead-out electrodes for controlling, making the electrochromic device to reach a state corresponding to the transmittance adjustment control signal. When it is determined that the entire electrochromic device requires to be adjusted, a required voltage is applied to the entire electrochromic device through the first lead-out electrode and the second lead-out electrode. When it is determined that one single electrochromic region in the electrochromic device requires to be adjusted, a required voltage is applied to the single electrochromic region through the first lead-out electrode and a third lead-out electrode that correspond to the single electrochromic region, or through two third lead-out electrodes corresponding to the single electrochromic region, or through the second lead-out electrode and a third lead-out electrode that correspond to the single electrochromic region. Additionally, when the electrochromic device includes three or more electrochromic regions, at least two of the electrochromic regions located between two lead-out electrodes spaced apart may also be controlled through the two lead-out electrodes to perform color changing.

On the basis of the preceding technical schemes, in an embodiment, if the entire electrochromic device is controlled, before the entire electrochromic device is controlled through the first lead-out electrode and the second lead-out electrode to perform color changing, the method further includes adjusting at least two electrochromic regions in the electrochromic device to have the same coloring degree or complementary coloring degrees. For the electrochromic device changing color in the same direction, the at least two electrochromic regions in the electrochromic device require to be adjusted to have the same coloring degree. For the electrochromic device changing color in different directions, the at least two electrochromic regions in the electrochromic device require to be adjusted to have the complementary coloring degrees. During the use of the electrochromic device, the case where the coloring degree of one single electrochromic region is adjusted independently may exist, that is, the one single electrochromic region is charged with a certain electric quantity. In this case, if the single electrochromic region is not adjusted to have the same coloring degree or complementary degree with other electrochromic regions, the single electrochromic region will be fully charged first in a process of controlling the entire electrochromic device, thereby limiting a charging process of the other electrochromic regions. After the single electrochromic region is fully charged, if a voltage continues to be applied to the single electrochromic region, the single electrochromic region may be damaged. If the voltage is not continued to be applied to the single electrochromic region, other electrochromic regions may not reach a state corresponding to the transmittance adjustment control signal. Therefore, before the entire electrochromic device is controlled, the at least two electrochromic regions in the electrochromic device may be first adjusted to have the same coloring degree or complementary coloring degrees, thereby guaranteeing the accuracy of a control result. For example, the open-circuit voltage of each electrochromic region may be monitored so that the at least two electrochromic regions of the same coloring degree or complementary coloring degrees can be implemented.

On the basis of the preceding technical schemes, in an embodiment, if the entire electrochromic device is controlled, before the at least two electrochromic regions in the electrochromic device are adjusted to have the same coloring degree or the complementary coloring degrees, the method further includes the following steps: It is determined whether each electrochromic region in the electrochromic device is damaged; and if a target electrochromic region being damaged exists, lead-out electrodes electrically connected to the two conductive layers in the target electrochromic region is shorted. In an embodiment, determining whether each electrochromic region in the electrochromic device is damaged includes the following: Each electrochromic region in the electrochromic device is controlled to perform color changing, and the current of each electrochromic region in a control process is acquired; and if a current of the target electrochromic region exceeding a preset current threshold exists, it is determined that the target electrochromic region is damaged. The preset current threshold is a current range having an upper current limit and a lower current limit. Before the entire electrochromic device is adjusted, each electrochromic region may be adjusted first to determine whether each electrochromic region is damaged. The current of each electrochromic region is acquired in an adjustment process. If a current exceeds the upper limit of the preset current threshold, it may be determined that a short circuit occurs in the corresponding single electrochromic region. If the current does not reach the lower limit of the preset current threshold, it may be determined that an open circuit occurs in the corresponding single electrochromic region. In these two cases, it is determined that the target electrochromic region is damaged, thus the lead-out electrodes electrically connected to the two conductive layers in the target electrochromic region are shorted to omit the target electrochromic region, thereby better implementing the preceding process in which the at least two electrochromic regions in the electrochromic device are adjusted to have the same coloring degree or complementary coloring degrees.

For the method for controlling an electrochromic device according to the embodiments of the present application, an adjustment manner of the electrochromic device is determined according to a received transmittance adjustment control signal, thereby implementing a process of adjusting the entire electrochromic device and adjusting a single region.

What is claimed is:

1. An electrochromic device, comprising:
at least two electrochromic regions, wherein each two adjacent electrochromic regions of the at least two electrochromic regions comprises a first electrochromic region and a second electrochromic region;
wherein the first electrochromic region comprises a first base layer, a first conductive layer, a first electrochromic layer, a second conductive layer, and a second base layer that are stacked in sequence; and
wherein the second electrochromic region comprises a third base layer, a third conductive layer, a second electrochromic layer, a fourth conductive layer, and a fourth base layer that are stacked in sequence;
wherein the first conductive layer is electrically connected to the third conductive layer; the second conductive layer is not in contact with the fourth conductive layer; and an edge of the first electrochromic layer is insulated from an edge of the second electrochromic layer; and
in a case where the first electrochromic region is located at a periphery of the electrochromic device, a first lead-out electrode is electrically connected to the second conductive layer; and
in a case where the second electrochromic region is located at the periphery of the electrochromic device, a second lead-out electrode is electrically connected to the fourth conductive layer.

2. The electrochromic device according to claim 1, wherein the first electrochromic layer comprises a first electrochromic material layer, a first ion conduction layer, and a first ion storage layer that are stacked in sequence; and
wherein the second electrochromic layer comprises a second electrochromic material layer, a second ion conduction layer, and a second ion storage layer that are stacked in sequence;
wherein the first electrochromic material layer is in proximity to the first conductive layer, and the second ion storage layer is in proximity to the third conductive layer; or
wherein the first ion storage layer is in proximity to the first conductive layer, and the second electrochromic material layer is in proximity to the third conductive layer.

3. The electrochromic device according to claim 1, wherein the first electrochromic layer comprises a first electrochromic material layer, a first ion conduction layer, and a first ion storage layer that are stacked in sequence; and
wherein the second electrochromic layer comprises a second electrochromic material layer, a second ion conduction layer, and a second ion storage layer that are stacked in sequence;
wherein the first electrochromic material layer is in proximity to the first conductive layer, and the second electrochromic material layer is in proximity to the third conductive layer; or
wherein the first ion storage layer is in proximity to the first conductive layer, and the second ion storage layer is in proximity to the third conductive layer.

4. The electrochromic device according to claim 1, wherein the at least two electrochromic regions have a same width.

5. The electrochromic device according to claim 1, wherein a third lead-out electrode is electrically connected to an electrical connection between the first conductive layer and the third conductive layer.

6. The electrochromic device according to claim 5, further comprising a controller, wherein the controller is connected to the first lead-out electrode, the second lead-out electrode, and at least one of the third lead-out electrode; and
wherein the controller is configured to control, through the first lead-out electrode and the second lead-out electrode, the electrochromic device to perform color changing and control, through the first lead-out electrode, the second lead-out electrode, and the at least one third lead-out electrode, each electrochromic region in the electrochromic device to perform color changing.

7. The electrochromic device according to claim 1, wherein a gap of a preset width is disposed between the edge of the first electrochromic layer and the edge of the second electrochromic layer to insulate the edge of the first electrochromic layer from the edge of the second electrochromic layer, or an electronic insulating material is disposed between the edge of the first electrochromic layer and the edge of the second electrochromic layer to insulate the edge of the first electrochromic layer from the edge of the second electrochromic layer.

8. The electrochromic device according to claim 7, wherein the electronic insulating material comprises an insulating colloid or an ionic conduction layer material.

9. The electrochromic device according to claim 1, wherein the first base layer and the fourth base layer are separated structures, and the second base layer and the third base layer are separated structures.

10. The electrochromic device according to claim 1, wherein the first base layer and the fourth base layer are arranged as an integrally connected structure, and/or the second base layer and the third base layer are arranged as an integrally connected structure.

11. The electrochromic device according to claim 1, wherein the first conductive layer and the third conductive layer are bonded through a conductive medium.

12. The electrochromic device according to claim 1, wherein the at least two electrochromic regions have different widths.

13. A method for controlling an electrochromic device, applied to the electrochromic device according to claim 6, comprising:
receiving a transmittance adjustment control signal of the electrochromic device;
determining, according to the transmittance adjustment control signal, whether the entire electrochromic device is controlled or a single electrochromic region in the electrochromic device is controlled;
in response to controlling the entire electrochromic device, controlling, through the first lead-out electrode of the electrochromic device and the second lead-out electrode of the electrochromic device, the entire electrochromic device to perform color changing; and
in response to controlling the single electrochromic region in the electrochromic device, controlling, through lead-out electrodes electrically connected to two conductive layers in the single electrochromic region, the single electrochromic region to perform color changing.

14. The method according to claim 13, wherein in a case where the entire electrochromic device is controlled, before the entire electrochromic device is controlled through the first lead-out electrode of the electrochromic device and the second lead-out electrode of the electrochromic device to perform color changing, the method further comprises:
adjusting the at least two electrochromic regions in the electrochromic device to have a same coloring degree or complementary coloring degrees.

15. The method according to claim 14, wherein in the case where the entire electrochromic device is controlled, before adjusting the at least two electrochromic regions in the electrochromic device to have the same coloring degree or the complementary coloring degrees, the method further comprises:
determining whether each electrochromic region in the electrochromic device is damaged; and
in response to presence of a target electrochromic region being damaged, shorting lead-out electrodes electrically connected to two conductive layers in the target electrochromic region.

16. The method according to claim 15, wherein the determining whether each electrochromic region in the electrochromic device is damaged comprises:
controlling each electrochromic region in the electrochromic device to perform color changing and acquiring a current of each electrochromic region in a control process; and
in a case of presence of a current of the target electrochromic region exceeding a preset current threshold, determining that the target electrochromic region is damaged.

17. The method according to claim 13, wherein the controlling, through the lead-out electrodes electrically connected to the two conductive layers in the single electrochromic region, the single electrochromic region to perform color changing comprises one of the following:
applying a required voltage to the single electrochromic region through the first lead-out electrode and a third lead-out electrode that correspond to the single electrochromic region;
applying a required voltage to the single electrochromic region through two third lead-out electrodes corresponding to the single electrochromic region; or
applying a required voltage to the single electrochromic region through the second lead-out electrode and a third lead-out electrode that correspond to the single electrochromic region.

18. The method according to claim 13, wherein the method further comprises:
when the electrochromic device comprises at least three electrochromic regions, controlling, through two spaced apart lead-out electrodes, at least two electrochromic regions which are among the at least three electrochromic regions and located between the two spaced apart lead-out electrodes to perform color changing.

19. The method according to claim 14, wherein the adjusting the at least two electrochromic regions in the electrochromic device to have the same coloring degree or the complementary coloring degrees comprises:
when the electrochromic device changes color in a same direction, adjusting the at least two electrochromic regions in the electrochromic device to have the same coloring degree; or
when the electrochromic device changes color in different directions, adjusting the at least two electrochromic regions in the electrochromic device to have the complementary coloring degrees.

20. The method according to claim 14, wherein the adjusting the at least two electrochromic regions in the electrochromic device to have the same coloring degree or the complementary coloring degrees comprises:
monitoring an open-circuit voltage of each of the at least two electrochromic regions.
